(19) United States
(12) Patent Application Publication
(10) Pub. No.: US 2012/0329019 A1
(43) Pub. Date: Dec. 27, 2012

(54) Biblical Guidance and Training Method

(76) Inventor: Danielle K. Dalton-Webb, McKinney, TX (US)

(21) Appl. No.: 13/168,749

(22) Filed: Jun. 24, 2011

(51) Int. Cl. G09B 19/00

(52) U.S. Cl. 434/245

(57) ABSTRACT

A method of mentoring groups of individuals in the effort to develop their relationship with God, as well as to train and develop their athletic skills while employing a unique player identification system based on biblical scripture numerals. The participants are divided into groups based on age and spiritual progression, as well as athletic training level, and are labeled according to religious scriptures and figures which correlate to the growth of the participants in their athletic training, as well as their progression towards God and a pious life.

### FIELD OF THE PRESENT INVENTION

An organizational method and structure, grounded in Biblical ideals, scriptures, and citations, configured to facilitate the guidance and training of individuals wishing to better their commitment and relationship with God, as well as to better develop physical assets and training pertaining to conventional sport activities including, but not limited to American football, soccer, basketball, track & field, and baseball. Participants in the method of the present invention are organized in a group or team structure that parallels the Bible, and are identified according to prudent and applicable or favorite bible scripture citation numerals, preferably printed as such on team athletic wear, such as jerseys, hats, bracelets, running shorts, etc.

### BACKGROUND OF THE PRESENT INVENTION

In modern society, professional athletics has become a multi-billion-dollar a year industry. As such, athletes are often compensated relatively well for the opportunity to play a professional sport for a licensed team, such as in the National Football League (NFL), National Basketball Association (NBA), the National Hockey League (NHL), and others. As a result of this insight, individuals are often motivated from a young age to pursue a career as a professional athlete for the fame, popularity, and substantial pay checks, given that they often witnessed the advancement of countless other athletes first-hand on television, in sports headlines.

Unfortunately, physical and financial success associated with athletic stardom often come hand-in-hand with greed, sloth, and the development of an elitist attitude towards others. This is often evidenced by negative newspaper headlines and news reports depicting stories of drug abuse, violence, cheating via steroid use, and a general lack of respect found amongst many successful sports athletes. This mentality is definitively opposed to the majority of religious teachings regarding the correct treatment of others, as well as the primary values of generosity and good sportsmanship.

Some churches, camps, and groups have had some success with bridging the world of athletics to religion, yielding positive results. However, the difficulty remains in ensuring that the participants retain the life skills and mannerisms obtained during their tenure at the church or camp beyond the duration of their attendance. If there were an effective strategy for continuing the growth and teachings of the athletic instructional institution or church into adulthood, through the use of identity shaping and encouraged or mentored growth, athletic individuals could remain true to themselves and to their ideals even in the face of athletic stardom. If such a program were to offer mentoring and athletic training to all ages of individuals, including adults, then the potential of the program would merely be limited by the time and effort an individual chooses to commit to the program, and to their selves. Similarly, if an identity system were to be employed that would cause participants to identify themselves as members of the program, as well as united followers of God, then players would incorporate the teachings and training from the program, both into their lives, and gameplay, as well as into their very identity as well.

Thus, there exists a need for a successful method and strategy with which a structured training and mentoring system, founded on Biblical ideals, can encourage, train, and develop athletic individuals of all ages, ingraining sound values through social exercises and team unity to benefit both the individual, as well as society as a whole. Additionally, an identity system should be employed to unite participants, and incorporate training, ideals, and lessons into their personal identity.

### SUMMARY OF THE PRESENT INVENTION

The present invention relates to a mentoring and training organizational structure geared to foster and encourage participants' athletic training as well as encourage a healthy spiritual relationship with God.

It is the intent of the present invention to encourage individuals to develop their talents as athletes as well as to live a reverent and religiously-minded or Christ-like life. Ideally, the output of the method of the present invention is the development of more Christian athletes in the world, potentially offsetting the often lewd and excessive or indecent behavior exhibited by many of today's modern athletes. The hope is that the religious influence of the program will help produce well rounded and respectful individuals who will retain this Christ-like spirit even when faced with financial success, peer pressure, and popularity within the culture as a result of their athletic achievements.

The present invention structurally divides participating individuals into an array of groups that parallel different stages of development or growth of the Apostles in their strength and conviction towards God, as depicted by the Bible. Overall, the bible depicts the Apostles as growing progressively in their relationship with Jesus. It is the intent of the preferred embodiment of the present invention to correlate the growth of the Apostles to the progression of the participating individuals or players in their relationship with Christ, paralleling their growth as athletes.

This notion is developed further during team exercises and game play via a unique team uniform attire and identity system which is presented as a substitute for the conventional player identification numbers placed commonly on team jerseys and other sports attire. The hope is that, through this endeavor, the program and structure can strive to encourage the youth to excel beyond their initial capacities both as athletes, as well as ministers of the Biblical word of God as depicted in the Gospel.

In the past, organizations have mentored and/or trained specific age groups causing the children to shift from one program to the next or opt out of participation all together. It is the intent of the present invention to combat this attrition with an exceptional program and an exciting atmosphere that will keep participants returning for years to come. The present invention employs many parables and lessons from the Bible, and therefore maintains the intent to “train a child in the way he should go, and when he is old he will not turn from it” (Proverbs 22:6). It is the responsibility of the program to follow the child's educational, physical, mental and spiritual development. A firm foundation must be set and reinforced throughout the life span of the individual in order to foster healthy spiritual growth, and ensure lessons are not lost over time.

### BRIEF DESCRIPTION OF THE DRAWINGS

FIG. 1 exhibits an exemplary embodiment of the instantiation of the numerical identification assignment process as presented on a football jersey.

FIG. 2 displays an embodiment of the website of the present invention.

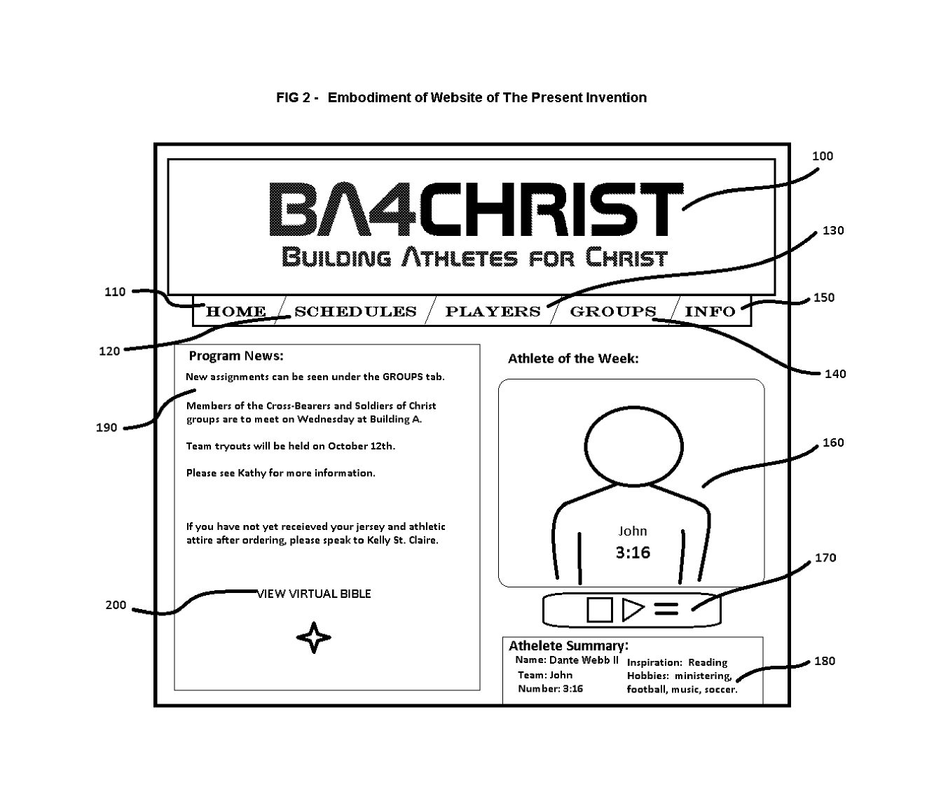

FIG. 3 shows the interrelation of the preferably five groups of participants of the preferred embodiment of the present invention.

### DETAILED DESCRIPTION OF THE PREFERRED EMBODIMENT

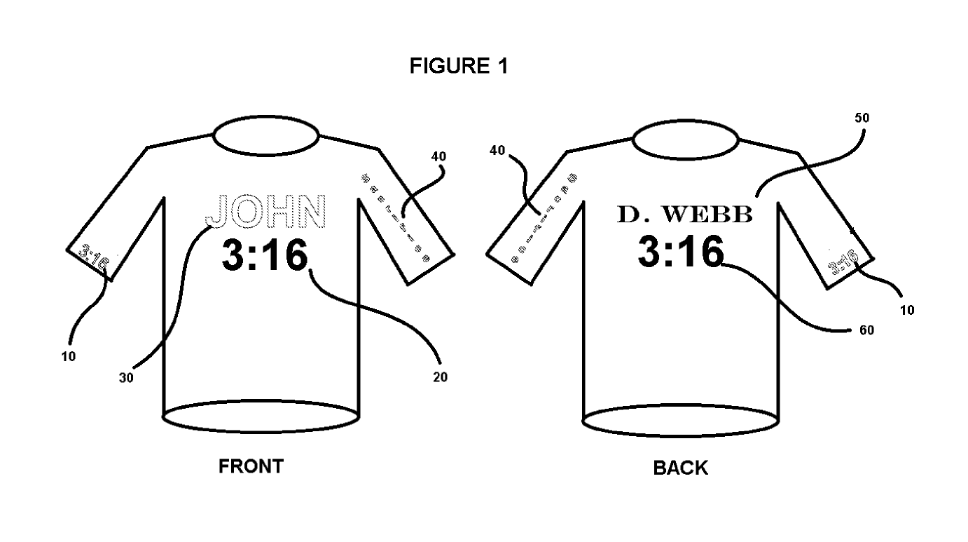

The present invention is a religion-based athletics training program designed to function as a continual center for the enrichment and development of both an individual's athletic abilities, as well as to grow and encourage the individual's relationship with God and the associated teachings of the bible as they pertain to life development, sportsmanship, moral character, and spiritual training for the extent of the individual's lifespan. The present invention accomplishes this feat through the implementation of a unique grouping system, designed to categorize participants into teams and groups based on age and skill level with terms that parallel those used in the bible, specifically those pertaining to the spiritual growth and development of the Apostles and other biblical figures. The mentoring and training program is centrally organized by a secured conventional server computer hosting a conventional web-based interface, conveying critical information pertaining to the program, including but not limited to schedules, team structures, extra lessons and readings, recommended exercises, etc. Additionally, a unique team and individual identification system is employed to unify team moral and integrate the systematic goals of athletic sports into the realm of biblical scriptures. This identification system is preferably exemplified in team athletic wear, as seen in the team jersey featured in FIG. 1.

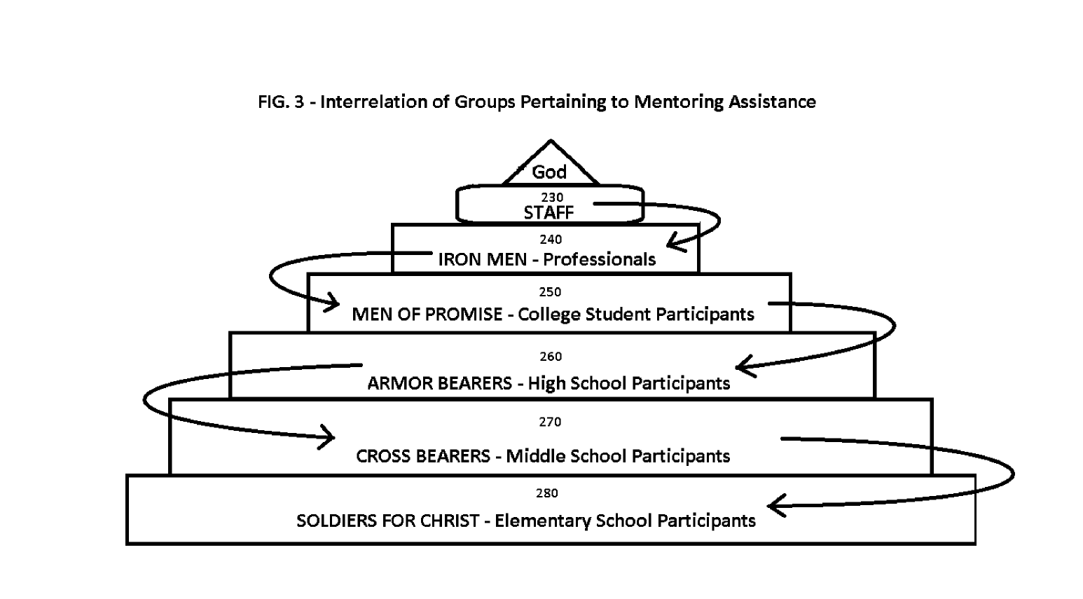

The preferred embodiment of the present invention is structured with a five tier grouping system for the individuals within the program, hereafter known as ‘participants.’ These five tiers preferably include: “Soldiers for Christ” (280) (Elementary School participants), “Cross Bearers” (270) (Junior High School or Middle School participants), “Armor Bearers” (260) (High School participants), “Men of Promise” (250) (College students), and “Iron Men” (240) (Professionals). The groups are organized such that each older group provides supplemental mentoring and support for each younger group to help foster continued education, as well as to provide the opportunity for groups to minister their expertise and spiritual fortitude to younger groups, providing a good example. The organization of this system can be seen in FIG. 3, which outlines the flow of mentoring assistance from the Staff (230), down to the Soldiers For Christ (280) through all of the classes of participants. The representation of these tiers is exemplified in the embodiment of the participants into The Broken (in Christ), Accepting Salvation, Protecting the Gift(s), Physical/Spiritual Training and Sharpening/Transforming Lives. Of the five tiers, three of them, preferably ‘Soldiers for Christ’ (280), ‘Cross Bearers’ (270), and ‘Armor Bearers’ (260) will maintain a secondary system of organized athletic teams. Each team will be titled as the name of one of the 66 books of the bible, and each team member will wear their favorite scripture reference from that book on their jersey, providing both a spiritual grounding for glorifying God through athletics, while simultaneously acting as an identification device for each player. An example can be seen in FIG. 1. For example: Player name (50): Dante Webb II; Team name (30): John; Favorite Scripture verse: John 3:16. Each element of the athletic wear is preferably embroidered, inscribed, or affixed via any similar conventional fabric printing method. Located on the left sleeve, one word can be found to describe the scripture reference (the player's identification number) that will both inspire others to look it up, thus spending more time with a bible, as well as to become a part of the players testimony (to witness to others about Christ). This approach is also geared to take the focus off the player, and rather place it on Christ instead, in order to implicate God as the giver of the athletic talents the participants preferably maintain, and in this way, praise God. The biblical verse identification serves to place emphasis on Christ and/or God at a time when most are concentrating on a game or on an individual player. In this way, participants may strive to honor God rather than themselves or a previous player by selecting their numbers in this manner. It will also allow them access to a greater numbering system since some numbers are already retired. In this way, the idolatry of athletic heroes is partially minimized, and attempts to place the glory of the talents exhibited in the sporting event to God, rather than the individual player. It is the goal of the numerical identification system of the present invention to be employed throughout the athletic life of the participant, especially if the participant is granted the opportunity to play a sport at a professional level.

Additionally, each participant will be involved in a weekly bible study geared toward their biblical team name. The names will vary for each age and skill level, giving the players knowledge and exposure to various books of the bible. All the groups unified denote a process, and each team unified an act of God depicted in the Bible. For example: Genesis—The Beginning, Exodus—Way Out/Deliverance, Leviticus—God's call to holiness and fellowship with Himself, etc.

The participant's journey with Christ, as well as the participant's progress, will be documented throughout the program and become a part of his player ‘Bio’ for future scouting inquiries (if applicable). In the preferred embodiment of the present invention, the player ‘bio,’ as well as the organization of the weekly bible study group is maintained on the program's central website. Group information can preferably be found under the ‘Groups’ tab (140). Schedules can preferably be found under the ‘Schedules’ tab (120), and player biographies can preferably be found under the Players tab (130). The website functions to track the progress of participants both in their spiritual advancement and education, as well as their physical training This content and associated player statistics will preferably be managed by the team leaders independently. The content is hosted on a secured server connected to the internet publicly, so that it may seen by all who wish to view it. General information about the program, as well as information pertaining to becoming a participant in the program can preferably be found under the ‘Info’ tab (150) of the preferred embodiment of the present invention.

Other features of the website of the present invention could include a Program News (190) section, which could feature various notes, news, and stories pertaining to the mentoring and training program. It can be envisioned that these alerts could be forwarded to members of the program via email or text message if the nature of the news or alert is crucial. The website could also feature an Athlete of the Week section, which would include a player's photo (160), as well as an Athlete Summary (180) to give viewers a better appreciate for the featured athlete.

In addition to serving as a central hub of information for the mentoring and training program, the website functions to eliminate much of the excess paperwork that is frequently associated with running an instructional camp or mentoring program. It can be envisioned that a digital version of the bible could be available on the website as well, to assist with the participants' studies and homework at home. The virtual bible can preferably be viewed from the website of the present invention, and is presented when the viewer of the website clicks on the ‘View Virtual Bible’ link (200). With this virtual bible, mentors could issue reading assignments preferably based on the participant's performance, behavior, or success during that week of the program.

Alternate embodiments of the present invention could include the application of the method of the present invention to groups of people holding other religious beliefs, wherein similar verse numerals in other sacred texts could be applied to teammate-identifying athletic wear, including but not limited to jerseys, shorts, socks, hats, etc. Additionally, this similar mentoring and numbering system could potentially bring honor to their superior being and style of worship.

An additional alternate embodiment of the present invention features two primary divisions of participants based on gender. Therefore, one mentoring program would be custom-tailored for males and their physical and spiritual advancement, and the other program would be conducive to training females, given that their physical training has slightly differing demands than that of males, and the period of adolescence treats each gender differently as well. The female mentoring and training program would run in conjunction with the male program, although they are not dependent on each other. The female program would also be divided into a series of sub-groups, each tailored for the specific age range and skill set of the participants involved. It can be envisioned that a total of preferably five groups of female participants would preferably be assembled to parallel the preferably five groups of males.

Additionally, it can be envisioned that the present invention could be configured to expand in scope beyond the initial church, school, or program building initially intended to house the program of the present invention. Other facilities could be created or conscripted to share participants, mentors, equipment, and even transportation to sporting events with other churches, schools, facilities, or buildings which are ideally running identical or similar mentoring programs in tandem with the initial school or church's mentoring program.

The present invention includes a robust tracking and scheduling tool, which is processed and displayed by a computer. The computer is also responsible for facilitating the assignment of biblical names to each group of participants. The computer also acts as the means by which participants are divided into groups, as well as tiering them according to predefined age ranges. These groups, in turn, provide academic and religious mentoring to one another, in accordance with scripture, as well as with accordance to the hierarchical tiering structure of the groups of participants. These groups are preferably then divided into subsets, maintaining a system of organized athletic teams. Each team of the system of organized athletic teams is preferably titled after a specified book of the Bible, each team maintaining a preferably different book from one of the 66 books of the Bible. Of the participants involved in these organized, titled teams, each team member (participant) wears a favorite or pertinent scripture reference on their team jersey, specific to the individual. Additionally, a numerical identity system is employed conveying the scripture reference on the sleeve via the numerical reference point in the corresponding book of the Bible as listed by the team name, titled after a book of the Bible. Each member of the organized teams meets with their team for scheduled bible study groups, group mentoring, and ministering to others. The computer tracks the participants progress, both in the study groups pertaining to religious education and mentoring, as well as the physical process of the team members, especially pertaining to their athletic advancement in their sport of choice.

I claim:

1. A biblical guidance and training method, comprising:
a computer dividing participants by age into groups;
the computer assigning biblical names to the groups;
the computer tiering the groups by age;
the groups providing academic and religious mentoring to one another.

2. The method of claim 1, further comprising a subset of the groups maintaining a system of organized athletic teams.

3. The method of claim 2, further comprising the computer titling each team of the system of organized athletic teams as a different name of one of the 66 books of the bible.

4. The method of claim 2, further comprising each team member of each team of the system of organized athletic teams wearing a favorite scripture reference on a jersey.

5. The method of claim 2, further comprising each team member of each team of the system of organized athletic teams wearing a favorite scripture reference on a jersey in place of a jersey number.

6. The method of claim 2, further comprising each team member, of each team of the system of organized athletic teams, wearing a word that is different than any other team member of a same team of the system of organized athletic teams, to describe a scripture reference on a left sleeve.

7. The method of claim 6, further comprising the computer identifying each team member by the one word on the left sleeve.

8. The method of claim 6, wherein the word represents a favorite scripture reference of each team member.

9. The method of claim 3, further comprising each team of the system of organized athletic teams meeting for bible study geared toward the different name of the one of the 66 books of the bible that the computer has titled for each team.

10. The method of claim 6, further comprising a computer tracking progress of each team member of each team of the system of organized athletic teams.
